(19) United States
(12) Patent Application Publication
(10) Pub. No.: US 2014/0118201 A1
(43) Pub. Date: May 1, 2014

(54) STRETCHABLE ANTENNA AND MANUFACTURING METHOD OF THE SAME

(71) Applicant: Samsung Electronics Co., Ltd., Suwon-si (KR)

(72) Inventors: Jung-kyun IM, Yongin-si (KR); Sang-hun JEON, Seoul (KR); Jong-jin PARK, Hwaseong-si (KR); Ji-hyun BAE, Seoul (KR)

(73) Assignee: Samsung Electronics Co., Ltd., Suwon-si (KR)

(21) Appl. No.: 14/067,001

(22) Filed: Oct. 30, 2013

(30) Foreign Application Priority Data
Oct. 30, 2012 (KR) 10-2012-0121542

(51) Int. Cl. H01Q 1/27; H01Q 1/38

(52) U.S. Cl. CPC H01Q 1/273; H01Q 1/38
USPC 343/718; 343/895; 343/904; 427/58; 427/123; 216/7

(57) ABSTRACT

Provided is a stretchable antenna including an elastic body that is stretchable and a conductive material disposed on the elastic body. The stretchable antenna may maintain stable characteristics in spite of numerous deformations. The stretchable antenna may be used as an antenna for a wireless communication device formed on a human body or clothing.

### CROSS-REFERENCE TO RELATED APPLICATION

This application claims priority from Korean Patent Application No. 10-2012-0121542, filed on Oct. 30, 2012 in the Korean Intellectual Property Office, the disclosure of which is incorporated herein in its entirety by reference.

### BACKGROUND

1. Field

Apparatuses and methods consistent with exemplary embodiments relate to a stretchable antenna, and more particularly, to a method of manufacturing a resistive memory device formed on a wearable device fiber.

2. Description of the Related Art

Along with an increase in the applied fields of electronic device, demand for an electronic device having a flexible or stretchable structure, as compared to an electronic device existing on a rigid substrate such as silicon or glass, has increased. For example, such fields as smart clothes, dielectric elastomer actuators (DEA), bio-adaptive electrodes, electric signal detection within living body, etc., have attracted interest.

An electronic device that including a sensor that may formed on clothes, or some other fiber platform, may need a communication medium, that is, an antenna, that may transmit obtained information or receive external information. The antenna may also be stretchable providing suitable characteristics for placement on a human body, clothes, or leather.

### SUMMARY

According to an aspect of an exemplary embodiment, there is provided a stretchable antenna including an elastic body that is stretchable, and a conductive material disposed on or in the elastic body.

The elastic body of the stretchable antenna may include a fiber.

The fiber may be formed from at least one of a natural fiber, a chemical fiber, and a mixture of the natural fiber and the chemical fiber.

The conductive material may be at least one of a metal, an alloy, and a metal composite including metal.

The conductive material may include at least one material selected from the group consisting of Ag, Na, Mg, Al, Si, K, Ca, Sc, Ti, Cr, Mn, Fe, Co, Ni, Cu, Zn, Ga, Ge, Rb, Sr, Y, Zr, Nb, Mo, Tc, Ru, Rh, Pd, Ag, Cd, In, Sn, Sb, Cs, Ba, Hf, Ta, W, Re, Ir, Pt, Au, Hg, Pb, La, Ce, Pr, Nd, Pm, Sm, Eu, Dy, Ho, Er, Tm, Yb, and Lu.

The stretchable antenna may further include at least one of a natural polymer and a synthetic polymer.

The stretchable antenna may be connected to a chip of a wireless communication device, and wherein the wireless communication device may be formed on at least one of a human body and clothing.

According to an aspect of another exemplary embodiment, there is provided a method of manufacturing a stretchable antenna, the method including performing a surface process on a surface of a wafer, forming a fiber mat on the wafer, and forming a conductive material on the fiber mat.

The forming of a conductive material may include disposing a mask having a mask shape on a surface of the fiber mat, and supplying a metal precursor to the surface of the fiber mat, and forming a metal layer on the surface of the fiber mat by reducing the metal precursor.

The method may further include removing the mask by an etching process.

### BRIEF DESCRIPTION OF THE DRAWINGS

These and/or other aspects will become more apparent and more readily appreciated from the following description of certain exemplary embodiments, taken in conjunction with the accompanying drawings in which:

FIG. 1A illustrates a stretchable antenna connected to an electronic device according to an exemplary embodiment;

FIGS. 1B through 1D illustrate examples of a stretchable antenna being applied for clothes according to an exemplary embodiment;

FIG. 2 is a flowchart of a method of forming a material of a stretchable antenna according to an exemplary embodiment;

FIGS. 3A through 3D illustrate a patterning forming process of a method of manufacturing a stretchable antenna according to an exemplary embodiment;

FIG. 4 is a graph showing the relationship between frequency and reflected power of a stretchable antenna according to an exemplary embodiment;

FIG. 5 is a graph showing a relationship between resonant frequency and tensile strain measured while varying the length of a stretchable antenna according to an exemplary embodiment; and

FIG. 6 is a graph showing a relationship between resonant frequency and reflected power according to repeated stretching, that is, the number of deformations, of a stretchable antenna according to an exemplary embodiment.

### DETAILED DESCRIPTION

Reference will now be made in detail to exemplary embodiments, examples of which are illustrated in the accompanying drawings, wherein like reference numerals refer to like elements throughout. In this regard, the exemplary embodiments may have different forms and should not be construed as being limited to the descriptions set forth herein. Accordingly, the exemplary embodiments are merely described below, by referring to the figures, to explain aspects of the present description. In the drawings, the thicknesses of layers and regions are exaggerated for clarity.

As used herein, the term “and/or” includes any and all combinations of one or more of the associated listed items. Expressions such as “at least one of,” when preceding a list of elements, modify the entire list of elements and do not modify the individual elements of the list.

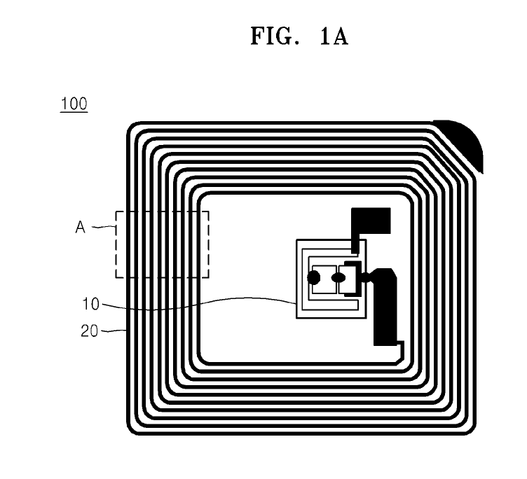

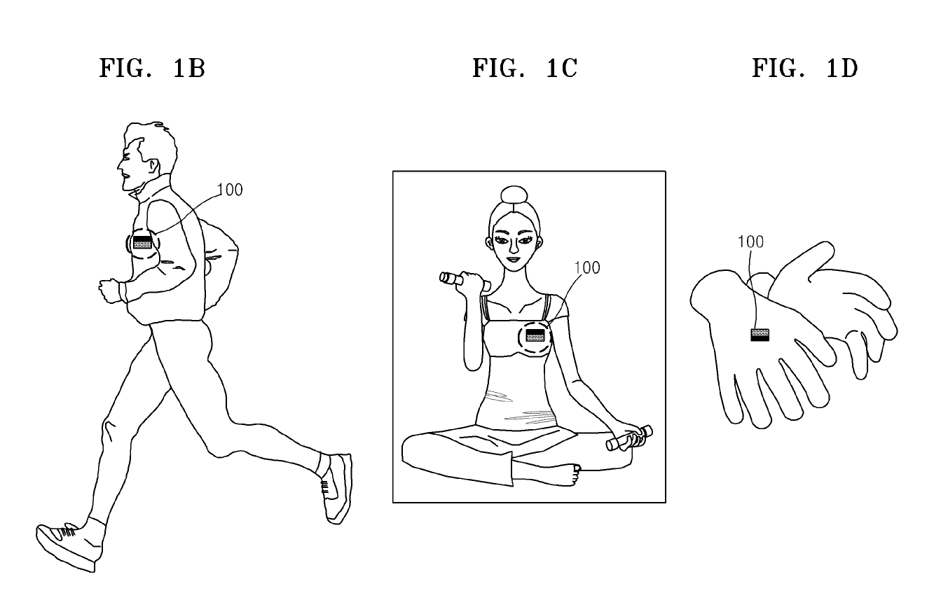

FIG. 1A illustrates a stretchable antenna 20 connected to an electronic device according to an exemplary embodiment. Referring to FIG. 1A, the stretchable antenna 20 according to the exemplary embodiment has a structure that is connected to a chip 10 of a wireless communication device 100. Although FIG. 1A illustrates a structure where the stretchable antenna 20 encompasses the chip 10 in tiers, the structure of the stretchable antenna 20 is not limited thereto and the stretchable antenna 20 may be formed as desired.

The wireless communication device 100 including the stretchable antenna 20 connected to the chip 10 may be disposed on or attached to a human body or clothes. Particularly, FIGS. 1B, 1C and 1D illustrate examples of the wireless communication device 100 being applied on various types of clothes. Because clothing is deformable, for example, being folded in various forms according to a movement of a human body, an antenna may be formed of a material having a characteristic of being easily deformable as well.

Accordingly, the stretchable antenna 20 according to the exemplary embodiment may be formed of an elastic body and a conductive material. The elastic body may use fiber as a stretchable material and may include woven fiber or non-woven fiber. The fiber may be a natural fiber, chemical fiber, or a compound thereof, for example, natural fiber made of wood pulp, flax, rami, hemp cloth, or wool, or chemical fiber made of vinylon, nylon, acryl, rayon, or asbestos fiber.

The elastic body may be a soft elastic body or a hard elastic body, or include both of a soft elastic body or a hard elastic body.

The conductive material may be an electrode material and may be metal, an alloy, or a metal composite including metal. Specifically, the conductive material may include at least one material selected from the group consisting of Ag, Na, Mg, Al, Si, K, Ca, Sc, Ti, Cr, Mn, Fe, Co, Ni, Cu, Zn, Ga, Ge, Rb, Sr, Y, Zr, Nb, Mo, Tc, Ru, Rh, Pd, Ag, Cd, In, Sn, Sb, Cs, Ba, Hf, Ta, W, Re, Ir, Pt, Au, Hg, Pb, La, Ce, Pr, Nd, Pm, Sm, Eu, Dy, Ho, Er, Tm, Yb, and Lu, or a metal oxide including at least one material thereof. As a conductive material such as metal is included in the stretchable antenna 20 forming a conductive network, the function of the stretchable antenna 20 may be maintained even when the shape of the stretchable antenna 20 is deformed.

The stretchable antenna 20 according to an exemplary embodiment may further include a polymer as an additive in addition to the elastic body and the conductive material. The polymer may be a natural polymer or a synthetic polymer. For example, the additive may be chiotosan, gelatin, collagen, elastin, hyaluronicacid, cellulose, silk fibroin, phospholipids, fibriongen, hemoglobin, fibrous calf thymus Na-DNA, virus M13 viruses, acetic acid, formic acid, tetrafluoroethylene (TFE), hexafluoroisopropanol (HFIP), tetrahydrofuran (THF), poly(D,L-latic-co-glycolic acid) (PLGA), poly lactic acid (PLA), poly(ε-caprolactone) (PCL), poly(3-hydroxybutyric-co-3-hydroxyvalelic) (PHBV), polylactide-caprolactone (PLCL), PLLA-DLA, ethylene-vinyl alcohol (EVOH), dimethylchloride (DCM), N,N-dimethylformamide (DCM/DMF), DCM/pyridine, DCM/methanol, chloroform, polyvinylpyrrolidone (PVP), polyethylene oxide (PEO), or polyvinyl alcohol (PVA).

The chip 10 connected to the stretchable antenna 20 in the wireless communication device 100 may be an electronic device such as various types of sensors, for example, radio frequency identification (RFID) chip or a Bluetooth chip, and may be connected for use with various sensor chips used for a variety of possible applications such as, for example, communication with other wearable electronic, medical devices, or other health care products.

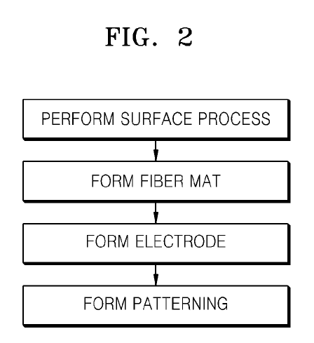

FIG. 2 is a flowchart for explaining a method of forming a material of the stretchable antenna 20. Referring to FIG. 2, a hydrophobic process may be performed on a surface of a wafer. In detail, a silicon wafer may be oxygen plasma processed and an octadecantrichlorosilane (OTS) monolayer may be formed on a surface of the silicon wafer. As such, the surface process may be performed to make the surface of a silicon substrate hydrophobic.

Next, a fiber mat may be formed on the wafer. In detail, a solution may be formed by adding poly(styrene-block-butadiene-block-styrene) (SBS, styrene 28.4 wt %) to a TMF/DMF solvent mixture. A fiber mat may be formed on the silicon wafer by using an electrospinning method. Then, the fiber mat may be separated from the silicon wafer and may be attached on a stretchable platform such as PDMS or ecoflex.

Next, a conductive material, that is, an electrode material, may be formed. In detail, the fiber mat may be dipped into an ethanol solution containing a metal precursor, for example, AgCF₃COO (15 wt %) that is a precursor, and a N₂H₄ gas is supplied to reduce the precursor. In this case, Ag metal may be combined to (i.e., disposed on or in) the fiber mat. According to the above process, an antenna may be formed that includes the fiber mat and metal that is a conductive material. Patterning may be performed to form a stretchable antenna having a desired shape.

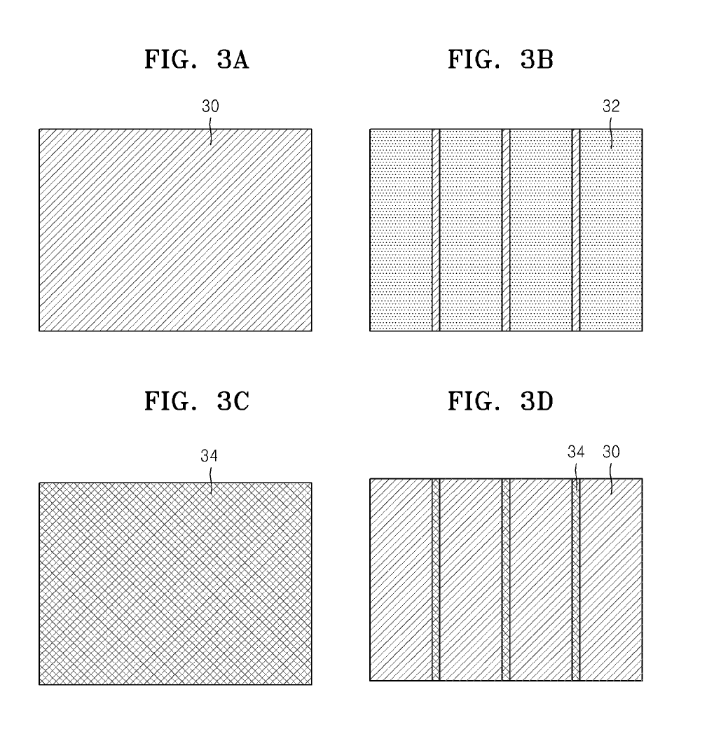

A variety of methods may be used to form a pattern of the stretchable antenna 20 as illustrated in FIG. 1A. FIGS. 3A through 3D illustrate an example of a pattern forming process of a method of manufacturing a stretchable antenna according to an exemplary embodiment. An example of forming an area A of the stretchable antenna 20 of FIG. 1A is discussed below.

Referring to FIG. 3A, a fiber mat 30 may be formed by the above-described method. As illustrated in FIG. 3B, a mask 32 having a predetermined mask may be located on a surface of the fiber mat 30. The mask 32 may be formed of ZnO.

As illustrated in FIG. 3C, an ethanol solution containing a metal precursor, for example, AgCF₃COO (15 wt %) that is a precursor may be supplied to upper surfaces of the fiber mat 30 and the mask 32 by a spray, inkjet, or printing process. When the precursor is reduced by supplying a N₂H₄ gas, the fiber mat 30 may be turned into a metal layer 34 as the metal precursor in an exposed portion is reduced. An area where the fiber mat 30 and the metal layer 34 are positioned together may have a stretchable antenna structure according to the exemplary embodiment.

Next, as illustrated in FIG. 3D, the mask layer 32 may be removed. The mask layer 32 may be removed by an etching process. For example, HF may be used as an etchant. Thus, the area where the fiber mat material and the metal layer 34 exist together may be formed to have a specific shape.

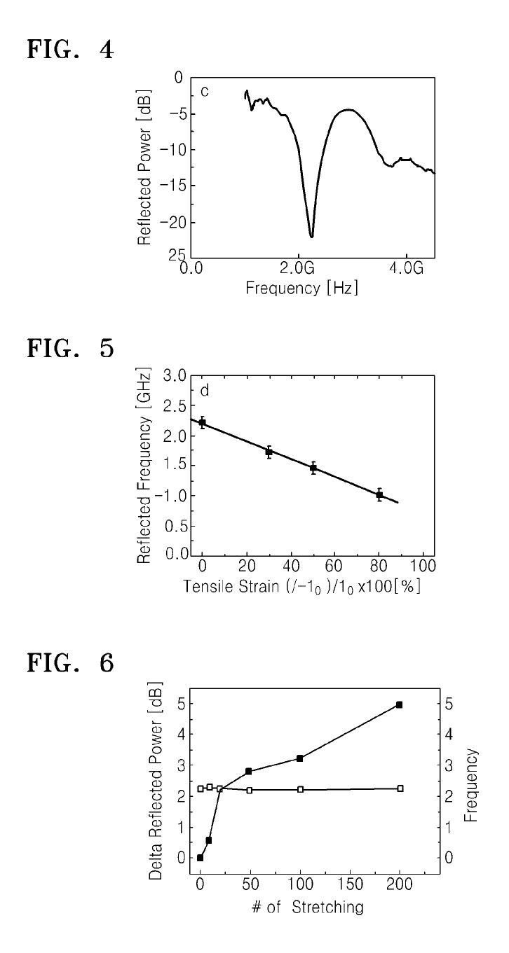

Results of measurements of the characteristics of the stretchable antenna 20 according to an exemplary embodiment is shown in FIGS. 4 through 6.

A stretchable antenna may be formed on a styrene-butadiene-styrene (SBS) fiber mat, which may be obtained by performing electrospinning on an ecoflex substrate, by reducing an Ag precursor to an Ag particle through a printing process and a reduction process. To form a dipole antenna, a subminiature version A (SMA) connector may be connected to a middle portion of the antenna in the lengthwise direction and ohmic contact may be formed and measured.

FIG. 4 is a graph showing the relationship between frequency and reflected power of a dipole antenna in the initial state, which may be measured just after the stretchable antenna is formed using the above-described method according to an exemplary embodiment. In this case, the length of the antenna is about 4.8 cm.

FIG. 5 is a graph showing the relationship between resonant frequency and tensile strain measured while varying the length of a stretchable antenna according to an exemplary embodiment. Referring to FIG. 5, it may be seen that the stretchable antenna according to the exemplary embodiment has elasticity and the resonant frequency varies according to a degree of deformation.

FIG. 6 is a graph showing a relationship between resonant frequency and reflected power according to repeated stretching, that is, the number of deformations, of a stretchable antenna according to another exemplary embodiment. FIG. 6 shows data related to reliability of the stretchable antenna.

Referring to FIG. 6, when the number of stretching is about 200, the resonant frequency is hardly changed, but the reflected power is reduced by about 5 dB. Considering that the initial value is about 22 dB, it may be seen that the reflected power has a value of 17 dB after about 200 times of stretching. When 99.9%, 99%, and 90% of input power are radiated from the antenna, the measured reflected power values are about −30 dB, −20 dB, and −10 dB, respectively. As a result, a value of 90% or higher may be still radiated.

As described above, according to the one or more of the above exemplary embodiments, a stretchable antenna that maintains a stable characteristic in spite of numerous deformations. Also, the stretchable antenna according to the present inventive concept may be used as an antenna of a wireless communication device formed on a human body or clothes.

It should be understood that the exemplary embodiments described therein should be considered in a descriptive sense only and not for purposes of limitation. Descriptions of features or aspects within each embodiment should typically be considered as available for other similar features or aspects in other embodiments.

What is claimed is:

1. A stretchable antenna comprising:
an elastic body that is stretchable; and
a conductive material disposed on or disposed in the elastic body.

2. The stretchable antenna of claim 1, wherein the elastic body comprises a fiber.

3. The stretchable antenna of claim 2, wherein the fiber comprises a natural fiber, a chemical fiber, or a mixture of the natural fiber and the chemical fiber.

4. The stretchable antenna of claim 1, wherein the conductive material comprises metal, an alloy, or a metal composite comprising metal.

5. The stretchable antenna of claim 1, wherein the conductive material comprises at least one material selected from the group consisting of Ag, Na, Mg, Al, Si, K, Ca, Sc, Ti, Cr, Mn, Fe, Co, Ni, Cu, Zn, Ga, Ge, Rb, Sr, Y, Zr, Nb, Mo, Tc, Ru, Rh, Pd, Ag, Cd, In, Sn, Sb, Cs, Ba, Hf, Ta, W, Re, Ir, Pt, Au, Hg, Pb, La, Ce, Pr, Nd, Pm, Sm, Eu, Dy, Ho, Er, Tm, Yb, and Lu.

6. The stretchable antenna of claim 1, further comprising at least one of a natural polymer and a synthetic polymer.

7. The stretchable antenna of claim 1, wherein the stretchable antenna is connected to a chip of a wireless communication device, and
wherein the wireless communication device is disposed on at least one of a human body and clothing.

8. A method of manufacturing a stretchable antenna, the method comprising:
performing a surface process on a surface of a wafer;
forming a fiber mat on the wafer; and
forming a conductive material on the fiber mat.

9. The method of claim 8, wherein the forming the conductive material comprises:
disposing a mask on a surface of the fiber mat; and
supplying a metal precursor to the surface of the fiber mat; and
forming a metal layer on the surface of the fiber mat by reducing the metal precursor.

10. The method of claim 9, further comprising removing the mask by an etching process.

11. A stretchable antenna comprising:
a fiber mat that is stretchable; and
a conductive material disposed on the fiber mat.

12. The stretchable antenna of claim 11, wherein the fiber mat is a styrene-butadiene-styrene (SBS) fiber mat.

13. The stretchable antenna of claim 11, wherein the conductive material is silver disposed on the fiber mat by precursor reduction.

14. The stretchable antenna of claim 11, wherein the stretchable antenna is shaped as a rectangular planar spiral coil.
